(19) United States
(12) Patent Application Publication
(10) Pub. No.: US 2023/0075444 A1
(43) Pub. Date: Mar. 9, 2023

(54) SHOWER AND FILTER ASSEMBLY

(71) Applicant: AS America, Inc., Piscataway, NJ (US)

(72) Inventors: Xiaojing Ye, Edison, NJ (US); Alanna Wing Libbrecht, Seattle, WA (US); Greg Reinecker, Brooklyn, NY (US)

(73) Assignee: AS America, Inc., Piscataway, NJ (US)

(21) Appl. No.: 17/798,436

(22) PCT Filed: Feb. 17, 2021
(86) PCT No.: PCT/US2021/018289

§ 371 Date: Aug. 9, 2022

Related U.S. Application Data
(60) Provisional application No. 62/977,781, filed on Feb. 18, 2020.

(51) Int. Cl. B05B 1/18; E03C 1/02; E03C 1/04; C02F 1/00

(52) U.S. Cl. CPC B05B 1/18; E03C 1/023; E03C 1/0408; C02F 1/003; C02F 2307/06; E03C 2201/40

(57) ABSTRACT

A shower assembly comprising a shower head; and a manifold configured to removably receive a water filter assembly; wherein the manifold comprises a bore having an outward-facing open end to receive the water filter assembly, wherein the manifold is downstream of and in fluid communication with a water source, and is upstream of and in fluid communication with the shower head.

The disclosure relates to plumbing fixtures comprising a filter assembly, as well as to filter assemblies and filter units.

### BACKGROUND

Household water is conveniently sterilized with chlorine. Hot water spray of a shower will convert dissolved chlorine to gas, where it may be inhaled. Household water may contain undesirable heavy metals, including lead. Household water may also contain other unwanted contaminates in addition to chlorine and heavy metals, for example, bacteria, algae, fungi, or certain minerals. Minerals including calcium, magnesium, iron, manganese, or other metals contribute to water “hardness” and may cause corrosion and scale formation.

Desired is a water filter which may remove unwanted contaminates from municipal and/or well water for use with household plumbing fixtures, including showers and baths. It is also desired that a water filter be easily installed and removed, without disassembling any part of the plumbing fixture.

### SUMMARY

Accordingly, disclosed is a shower assembly comprising a shower head and a manifold, the manifold configured to removably receive a water filter assembly; wherein the manifold comprises a bore having an outward-facing open end to receive the water filter assembly and a fluid inlet and a fluid outlet, the manifold inlet is downstream of and in fluid communication with a water source, and the manifold outlet is upstream of and in fluid communication with the shower head.

Also disclosed is the shower assembly comprising the shower head and the manifold and having a filter assembly removably positioned in the manifold bore and coupled to the manifold.

Also disclosed is an add-on water filter unit, the add-on unit configured to removably receive a water filter assembly and to be installed in-line in a shower assembly, downstream of and in fluid communication with a water source and upstream of and in fluid communication with a shower head.

Also disclosed is a water filter cartridge comprising a continuous wall defined by a first end and an opposing second end, wherein the first end is continuous and the second end comprises a water filter inlet and a water filter outlet.

Also disclosed is a water filter assembly comprising the water filter cartridge and a cap.

The assemblies of the disclosure provide filtered water with easily replaced, compact water filters, and wherein no parts of a shower assembly other than the filter assembly need be disassembled or manipulated in order to install and remove the filter.

### BRIEF DESCRIPTION OF THE DRAWINGS

The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1A depicts a hand shower having a filter assembly and manifold positioned along a shower bar, according to an embodiment.

FIG. 1B shows the hand shower of FIG. 1A with the filter assembly in exploded view.

FIG. 1C provides a cross-section view of the shower bar of FIG. 1A.

FIG. 1D provides an expanded cross-section view of the filter assembly and manifold of FIG. 1A.

FIG. 1E shows a perspective view of a filter cartridge, according to an embodiment.

FIG. 1F provides an exploded view of a filter assembly, according to an embodiment.

FIG. 1G shows a filter assembly filter cap, according to an embodiment.

FIG. 1H provides a cross-section view of a manifold, according to an embodiment.

FIG. 1I shows a front, perspective view of a manifold configured to couple to a filter assembly, according to an embodiment.

FIG. 2A and FIG. 2B show a shower head comprising a filter cartridge, according to an embodiment.

FIG. 2C and FIG. 2D show a shower head comprising a filter cartridge, according to an embodiment.

FIG. 3A and FIG. 3B depict a hand shower having a hand shower cradle with a filter assembly, according to an embodiment.

FIG. 3C and FIG. 3D show a fixed shower head coupled to an add-on water filter unit, according to an embodiment.

FIG. 3E and FIG. 3F illustrate a docking hand shower, according to an embodiment.

FIG. 4A and FIG. 4B depict a filter assembly coupled to a shower valve, according to an embodiment.

FIG. 5A and FIG. 5B show a shower assembly comprising a hand shower and a fixed shower head, according to an embodiment.

FIG. 6A provides an exploded view of components of a 2-in-1 shower assembly, according to an embodiment.

FIG. 6B shows a 2-in-1 shower assembly, according to an embodiment.

FIG. 6C provides a cross-section view of a 2-in-1 shower assembly, according to an embodiment.

FIG. 7A, FIG. 7B and FIG. 7C show a shower head and a hand shower with a non-cylindrical shaped filter cartridge, according to an embodiment.

FIG. 8A and FIG. 8B depict a shower head and a non-cylindrical shaped filter cartridge and a hand shower/cradle arrangement, according to an embodiment.

FIG. 9A and FIG. 9B show a shower head and a hand shower with a substantially cylinder-shaped filter cartridge, according to an embodiment.

FIG. 10A and FIG. 10B depict a shower head and a hand shower with a non-annular, non-cylindrical shaped filter cartridge, according to an embodiment.

### DETAILED DISCLOSURE

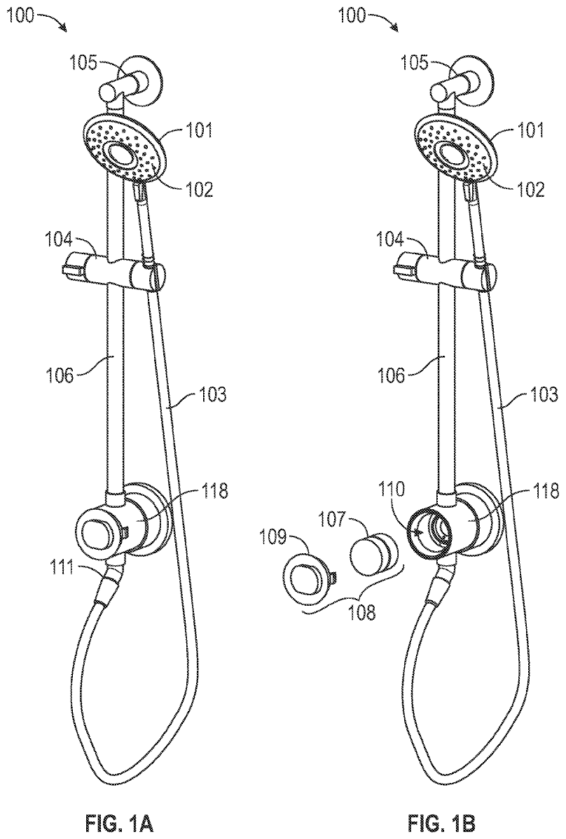

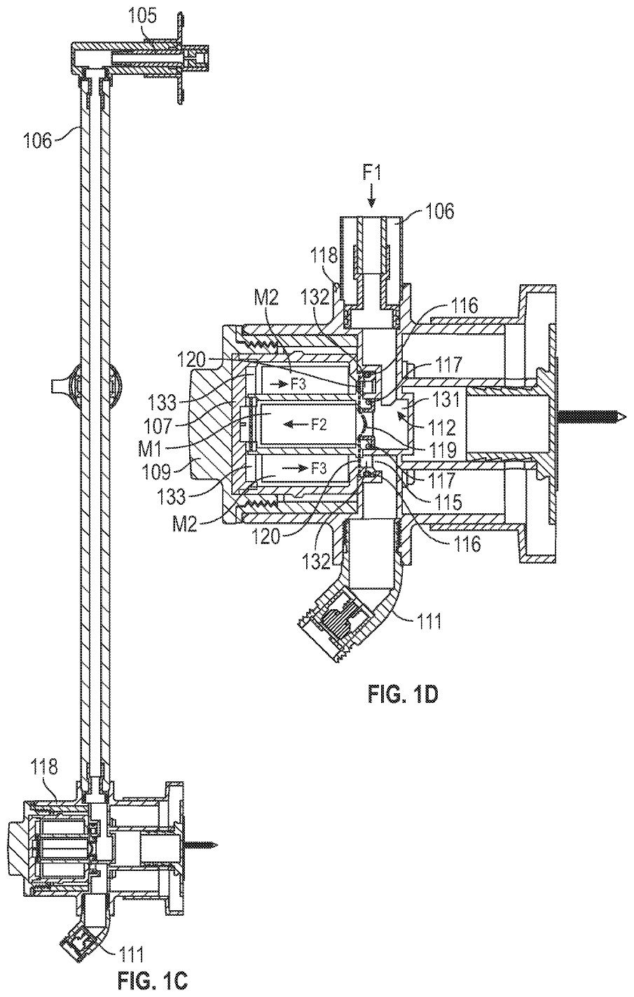

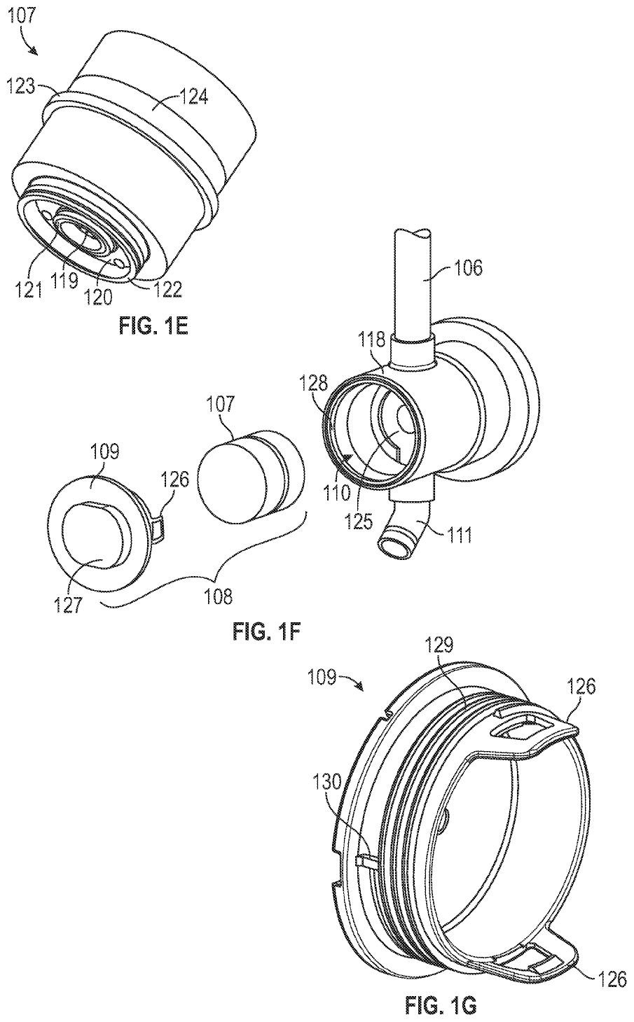

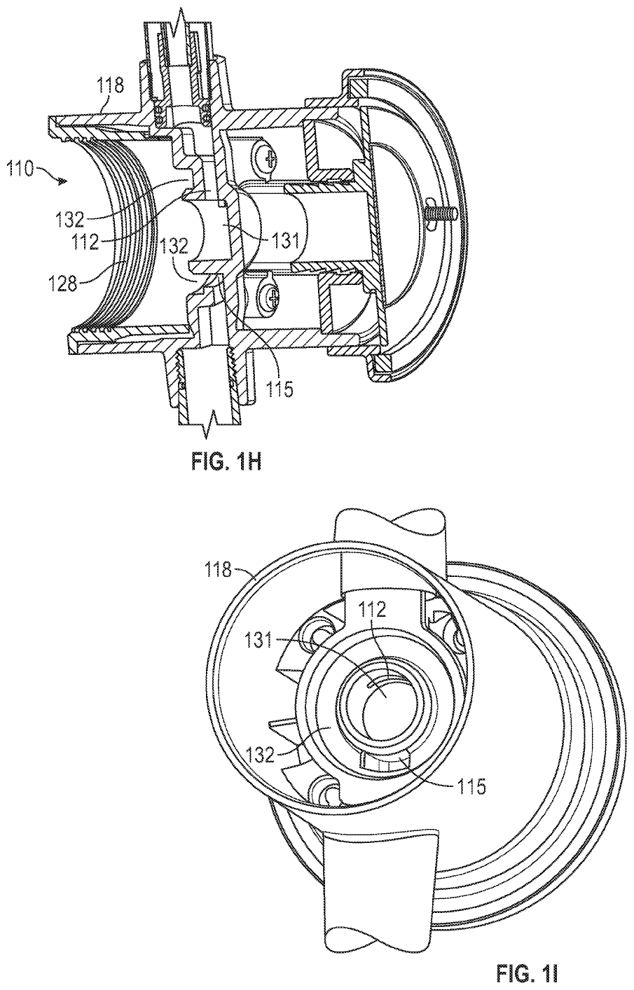

FIG. 1A and FIG. 1B show a hand shower 100 configured to dispense filtered shower water, according to an embodiment. Hand shower 100 includes spray head 101 containing a plurality of spray nozzles 102 to emit shower water. Spray head 101 is coupled to and in fluid communication with flexible hose 103 and is shown docked to adjustable height adapter 104. Source water is provided through water inlet 105, is passed through shower bar 106, filter cartridge 107, and filtered water is delivered to shower head 101 via hose 103. Hose 103 is coupled to manifold 118 via elbow joint 111. Filter assembly 108, comprising filter cap 109 and filter cartridge 107, is removably disposed in cylinder-shaped bore 110 of manifold 118 via threaded engagement between filter cap 109 and an interior threaded portion of manifold 118. No parts of shower assembly 100 need be manipulated in order to install and remove filter assembly 108, except for filter assembly 108 itself.

FIG. 1C shows a cross-section view of a portion of shower assembly 100 having manifold 118 containing filter assembly 108 positioned along shower bar 106. FIG. 1D provides an expanded view of a portion including manifold 118. Inlet 105 is fluidly connected to a water source upon installation of assembly 100. Manifold inlet 131 and outlet 132 are positioned towards (at) an inner end of bore 110. Manifold inlet 131 contains inlet port 112 and outlet port 115. Manifold inlet 131 is coupled to filter assembly inlet 119 and manifold outlet 132 is coupled to filter assembly outlet 120. Coupling is formed via outlet O-ring 116 and inlet O-ring 117 positioned in grooves about filter assembly outlet 120 and filter assembly inlet 119, respectively.

Upon actuation of shower assembly 100, manifold inlet 131 receives source water in a first flow direction F1 and directs source water to filter assembly inlet 119 in a second flow direction F2, and manifold outlet 132 receives filtered water from filter assembly outlet 120 in a third flow direction F3 and directs filtered water out of manifold 118.

In this embodiment, manifold outlet 132 is coplanar with manifold inlet 131, and manifold outlet 132 and manifold inlet 131 are axially aligned (coaxial). Flow path F2 and flow path F3 are axially aligned and are substantially opposite each other. Source water will pass through filter media M1 in direction F2 and into open space 133, and through filter media M2 in direction F3 from open space 133. Filter media M1 and M2 in this embodiment are concentric. Filter media M1 and M2 may be the same or different.

FIG. 1E shows a perspective view of filter cartridge 107, from the inlet/outlet end, according to an embodiment. Visible are water filter assembly inlet 119 and water filter assembly outlet 120. Filter inlet 119 and outlet 120 have grooves about them fitted with O-rings 117 and 116, respectively. Filter inlet 119 and outlet 120 each have a plurality of inlets and outlets, respectively. Filter cartridge 107 comprises outwardly extending encircling feature 123 configured to engage a filter cap. Filter cartridge 107 may be reversibly opened and closed, for instance via threaded engagement at point 124, to remove and recycle, and to re-charge filter media. Filter cartridge 107 comprises annular inlet radial extension 121 and annular outlet radial extension 122.

FIG. 1F provides an expanded exploded view of filter assembly 108 comprising filter cap 109 and filter cartridge 107, aligned for insertion into manifold bore 110. Visible is an inner end 125 of bore 110, containing manifold inlet 131 and outlet 132 (not visible). FIG. 1G provides an inner perspective view of cap 109. Cap 109 may be removably coupled over an outward-facing continuous end of filter cartridge 107 via snap features 126 and extending feature 123. Manifold bore 110 comprises threaded portion 128 configured to removably threadingly engage threaded portion 129 of cap 109. Cap 109 comprises a stop feature 130 configured to horizontally align cap handle 127 upon installation.

FIG. 1H shows a cross-section view of manifold 118 and manifold bore 110, according to an embodiment. Visible are manifold inlet 131, manifold outlet 132, and bore threaded portion 128. FIG. 1I shows a perspective view of manifold 118, according to an embodiment. O-rings 117 and 116 on filter cartridge 107 may form a seal in manifold inlet 131 and manifold outlet 132, respectively. Manifold inlet 131 which will couple with filter assembly inlet 119 and manifold outlet 132 which will couple with filter assembly outlet 120. Manifold inlet 131 is coaxial and coplanar with manifold outlet 132. Filter cartridge extension 121 will mate with manifold inlet 131 and cartridge extension 122 will mate with manifold outlet 132. FIG. 1H and FIG. 1I also show manifold inlet port 112 and manifold outlet port 115, in fluid communication with manifold inlet 131 and manifold outlet 132, respectively.

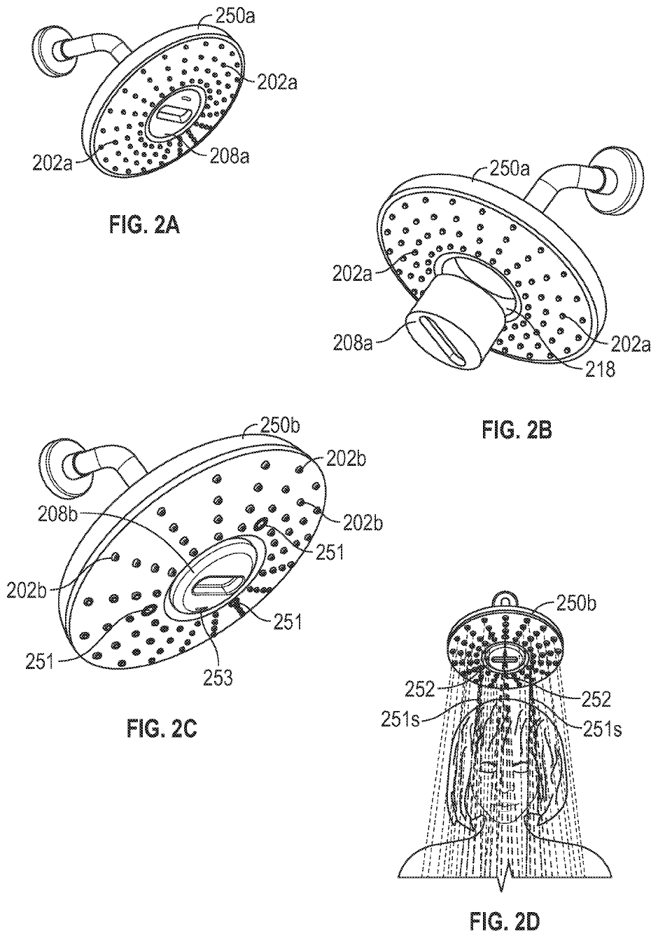

FIG. 2A and FIG. 2B show a shower head 250a, comprising spray nozzles 202a for dispensing a shower spray, according to an embodiment. Spray head 250a comprises manifold 218 having an open outward-facing end to receive filter assembly 208a. Filter assembly 208a will have one or more features towards an inner end configured to removably couple it to manifold 218 via a quarter turn. Manifold 218 and filter assembly 208a are downstream of and in fluid communication with a water source, and are upstream of, and in fluid communication with shower head nozzles 202a.

FIG. 2C and FIG. 2D show similar shower head 250b, containing filter assembly 208b, according to an embodiment. Shower head 250b comprises spray nozzles 202b, and supplemental spray nozzles 251. Filter assembly 208b, positioned at a center of shower head 250b, may create a “dead zone” lacking shower spray. Supplemental spray nozzles 251 provide a spray 252 to compensate for a dead zone. Spray 251s indicates spray from supplemental nozzles 251. Filter assembly 208b contains indicator light 253, which may provide useful life information regarding filter assembly 208b.

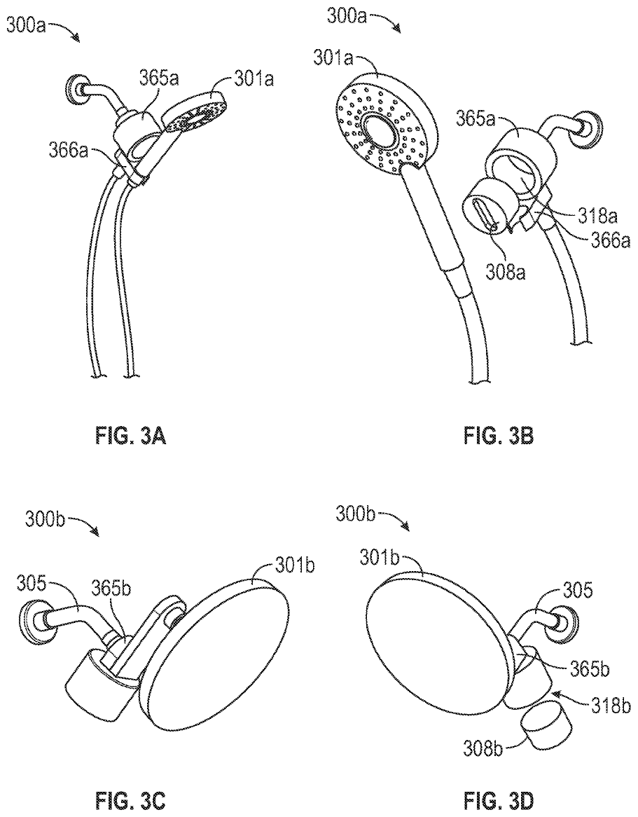

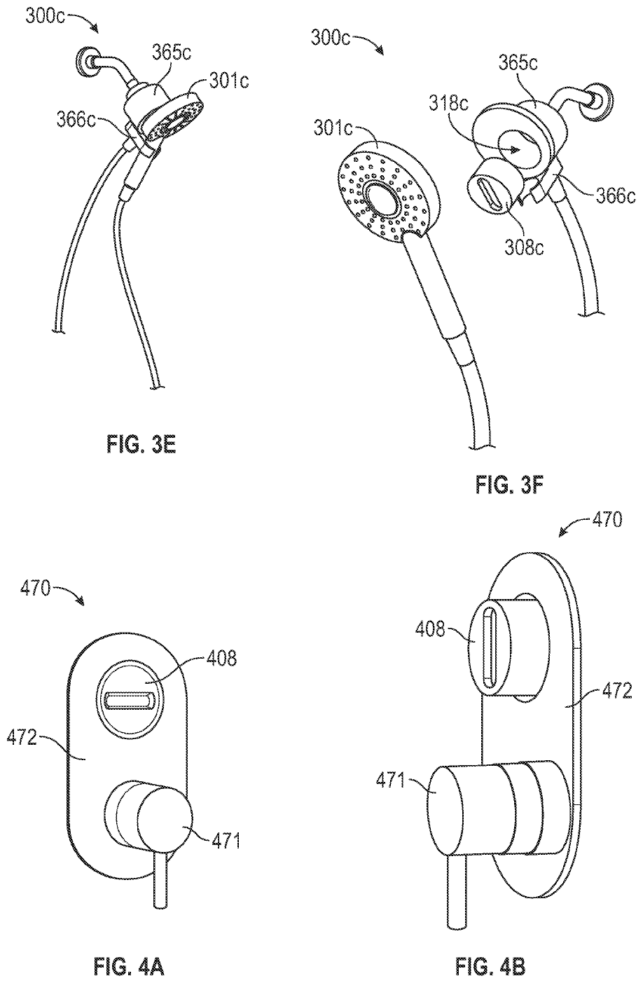

FIG. 3A and FIG. 3B illustrate hand shower assembly 300a, according to an embodiment. Hand shower assembly 300a comprises add-on water filter unit 365a comprising a hand shower cradle 366a. Water filter unit 365a is positioned in-line in assembly 300a, downstream of and in fluid communication with a water source, and upstream of, and in fluid communication with shower head 301a. Manifold 318a comprises an open outward-facing end configured to receive water filter assembly 308a.

FIG. 3C and FIG. 3D depict shower assembly 300b, according to an embodiment. Assembly 300b contains add-on water filter unit 365b, directly coupled to inlet pipe 305 and fixed shower head 301b. Unit 365b comprises manifold 318b (not visible) configured to receive filter assembly 308b. Manifold 318b is downstream of, and in fluid communication with inlet pipe 305 and is upstream of, and in fluid communication with shower head 301b.

FIG. 3E and FIG. 3F illustrate docking hand shower assembly 300c, according to an embodiment. Add-on water filter unit 365c comprises hand shower cradle 366c and manifold 318c. Manifold 318c comprises an outward-facing open end to receive and couple with filter assembly 308c. Cradle 366c is configured to hold hand shower head 301c. Water filter unit 365c may comprise a magnetic surface with which to dock shower head 301c.

FIG. 4A and FIG. 4B show an in-wall valve assembly portion 470 of a shower assembly, according to an embodiment. In-wall valve assembly 470 comprises handle 471 coupled to and configured to manipulate for instance a pressure balance valve or a thermostatic valve. Filter assembly 408 is positioned in plate 472 together with handle 471. Filter assembly 408 may couple to a manifold (not visible) in the valve assembly via a quarter turn. Filter assembly 408 may be downstream of, and in fluid communication with a shower valve and upstream of, and in fluid communication with a shower head.

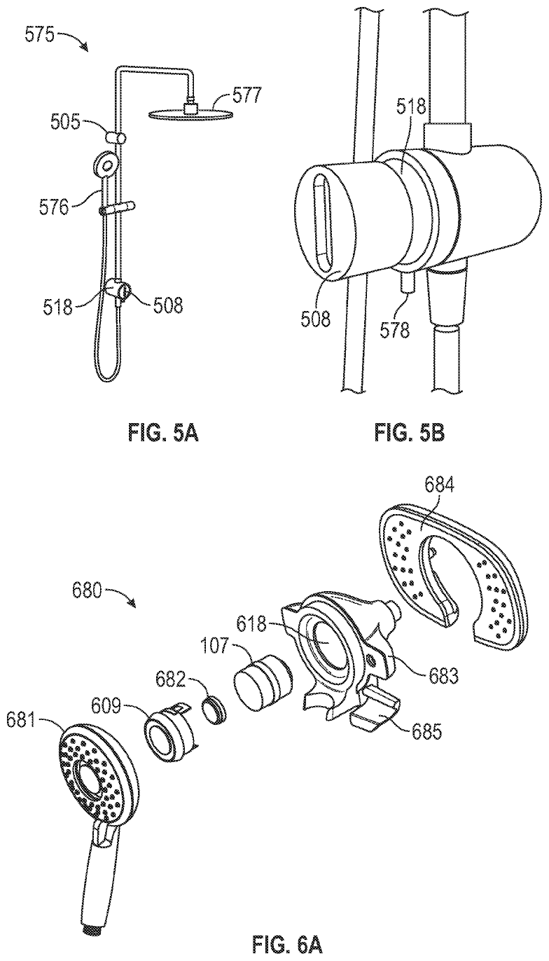

FIG. 5A depicts shower assembly 575 comprising hand shower 576 and shower head 577, according to an embodiment. FIG. 5B provides an enlarged view of manifold 518 and filter assembly 508, positioned for insertion into an outward-facing open end of manifold 518. Directly coupled to manifold 518 is diverter 578, positioned downstream of and in fluid communication with manifold 518. Diverter 578 may direct water to hand shower 576 and/or shower head 577. Manifold 518 is in fluid communication with fluid inlet 505.

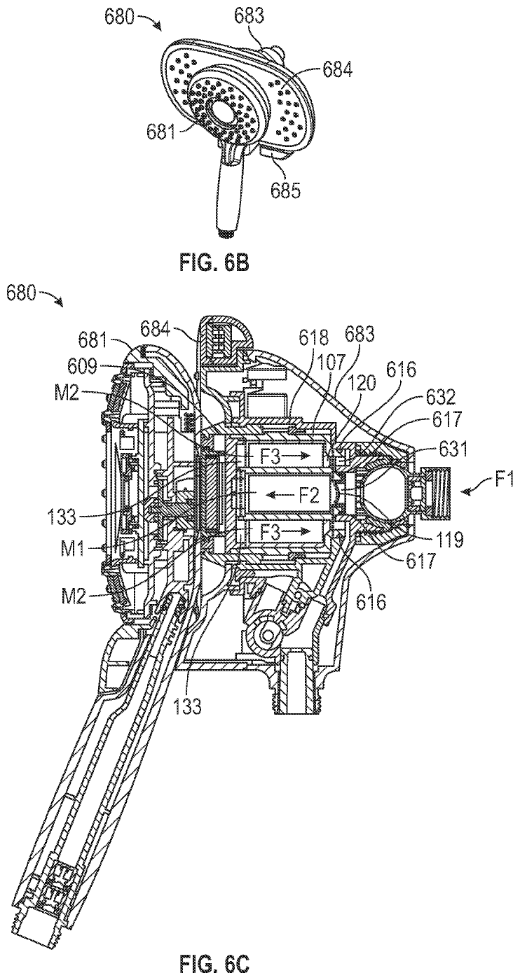

FIG. 6A provides an exploded view of components of “2-in-1” shower assembly 680, according to an embodiment. Shown are hand shower 681, filter cap 609, magnet 682, filter cartridge 107, diverter unit 683, and shower head 684. Diverter unit 683 contains diverter lever 685 and manifold 618. Magnet 682 is part of filter assembly 608 and is configured to dock hand shower 681. FIG. 6B shows shower assembly 680 with hand shower 681 docked to diverter unit 683 and shower head 684.

FIG. 6C provides a cross-section view of shower assembly 680, according to an embodiment. Visible are manifold 618, filter cartridge 107, diverter unit 683, shower head 684, hand shower 681, filter cap 609, and magnet 682. Filter cartridge 107 is positioned in a cylinder-shaped bore of manifold 618 and manifold inlet 631 and manifold outlet 632 are positioned towards an inner end of the bore. Manifold inlet 631 is coupled to filter assembly inlet 119 and manifold outlet 632 is coupled to filter assembly outlet 120. Coupling is formed via outlet O-ring 616 and inlet O-ring 617 positioned in grooves about filter cartridge outlet 120 and inlet 119, respectively. O-rings 616 and 617 are positioned in grooves on filter cartridge 107 and form seals in manifold outlet 632 and manifold inlet 631, respectively.

Upon actuation of shower assembly 680, manifold inlet 631 receives source water in a first flow direction F1 and directs source water to filter cartridge inlet 119 in a second flow direction F2, and manifold outlet 632 receives filtered water from filter cartridge outlet 120 in a third flow direction F3 and directs filtered water out of manifold 618.

Source water will pass through filter media M1 in direction F2 and into open space 133, and through filter media M2 in direction F3 from open space 133. Filter media M1 and M2 in this embodiment are concentric. Filter media M1 and M2 may be the same or different.

In this embodiment, manifold outlet 632 is coplanar with manifold inlet 631 and manifold outlet 632 and inlet 631 are axially aligned. Flow path F2 and flow path F3 are axially aligned and are substantially opposite each other. Flow paths F1 and F2 are axially aligned and are substantially in the same direction. Source water will pass through filter medial M1 in direction F2 and through filter medial M2 in direction F3. Filter medial M1 and M2 in this embodiment are concentric and may be the same or different media.

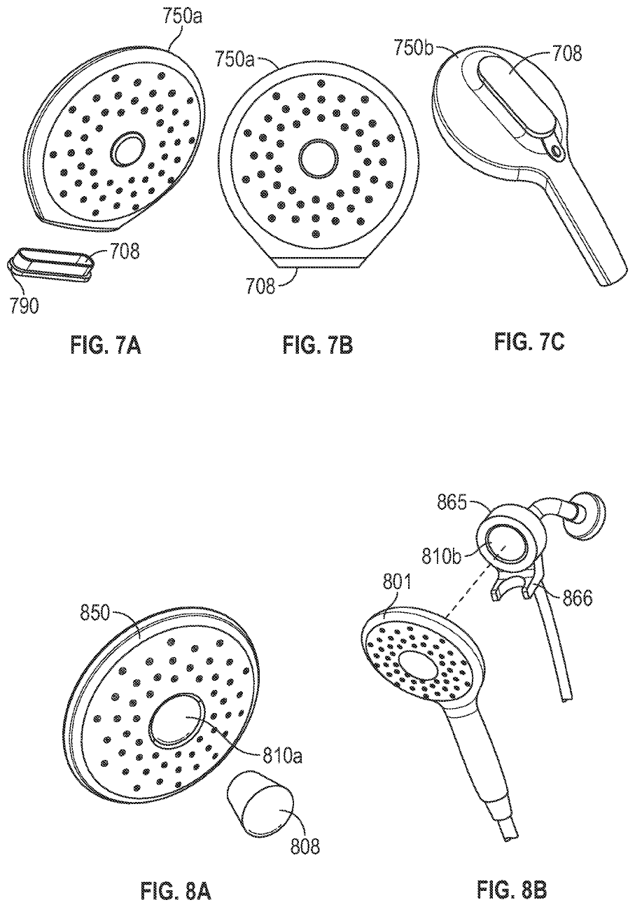

FIG. 7A, FIG. 7B and FIG. 7C depict a shower head 750a and a hand shower 750b with a non-cylindrical/non-annular shaped filter cartridge 708, according to an embodiment. Filter cartridge 708 may be inserted into a manifold bore positioned at a lower edge of shower head 750a. Filter cartridge 708 may be inserted into a manifold bore positioned on a rear of hand shower 750b. Filter cartridge 708 comprises extending ridge 790 around its perimeter, configured to allow one to grip for insertion/removal.

FIG. 8A and FIG. 8B depict a shower head 850, a hand shower 801, and a non-cylindrical shaped filter cartridge 808, according to an embodiment. Filter cartridge 808 may simply be “plugged” into manifold bore 810a and/or manifold bore 810b of shower head 850 or of add-on assembly 865, respectively. Add-on assembly 865 comprises a filter manifold (not visible) and cradle 866. Add-on assembly 865 is in fluid communication with a water source and hand shower 801.

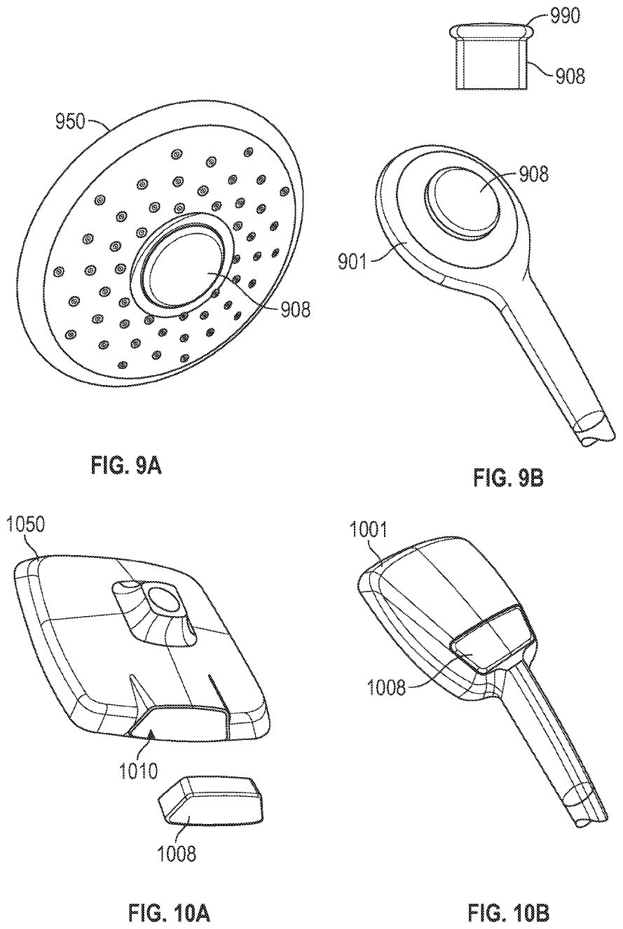

FIG. 9A and FIG. 9B show a shower head 950 and a hand shower 901 with a substantially cylinder-shaped filter cartridge 908, according to an embodiment. Filter cartridge 908 has an annular extending grip portion 990 for inserting or removing it from a manifold bore. Filter cartridge 908 may be inserted in a manifold bore positioned in a face center of shower head 950 or a rear portion of hand shower 901.

FIG. 10A and FIG. 10B depict a shower head 1050 and a hand shower 1001 with a non-annular, non-cylindrical shaped filter cartridge 1008, according to an embodiment. Filter cartridge 1008 may be inserted into manifold bore 1010 positioned in a bottom portion of shower head 1050 or a manifold bore positioned in a rear portion of hand shower 1001.

In some embodiments, disclosed is a shower assembly comprising a water filter assembly, wherein the water filter assembly may installed and removed without disassembling any shower assembly parts. A water filter assembly may simply be installed and removed from a filter manifold which is part of the shower assembly or part of an add-on assembly.

In some embodiments, a single filter cartridge may be employed for the various configurations disclosed, for example wherein a filter cartridge/filter assembly is disposed in a manifold positioned in a shower bar, in a shower head, in an add-on unit, in a diverter unit, in an in-wall valve assembly, etc. In some embodiments, a filter manifold may be directly coupled to a diverter, wherein the diverter is configured to direct filtered water to a shower head and/or a hand shower.

In certain embodiments, a filter manifold may be positioned along a shower bar. In some embodiments, a filter manifold is configured to deliver filtered water to a hand shower. A shower bar may be in fluid communication with source water and a hand shower via a filter manifold.

A shower head may be a fixed shower head or a hand shower removably coupled to a cradle. A shower head comprises a plurality of nozzles (or spray nozzles) to deliver shower water or shower spray. Accordingly, a hand shower is also a shower head. In general, the term “shower head” refers to a “fixed” shower head—a shower head that may not be removed from a certain position (but that can be locally adjusted).

In some embodiments, a filter manifold may be positioned in a shower head face, centered in the shower head or off-center. In some embodiments, a filter manifold positioned in a shower head face may result in a “dead zone” lacking shower spray. In some embodiments, a shower head may contain supplemental spray nozzles to adjust for and compensate for a spray dead zone.

In other embodiments, a filter manifold may be positioned in a shower head back, a shower head top, a shower head side, or a shower head bottom section.

In some embodiments, a filter manifold may be part of an add-on assembly. An add-on assembly may be permanently coupled to a shower assembly and in fluid communication with a water source and a shower head. Accordingly an add-on assembly may receive source water and provide filtered water. In some embodiments, an add-on assembly may comprise a cradle to hold a hand shower.

In some embodiments, a filter manifold may be part of a diverter unit, wherein the diverter unit is configured to selectively direct filtered water flow from a filter manifold to one or both of a shower head or a hand shower. The shower head may be removably coupled to the diverter unit. The hand shower is fluidly coupled to the diverter unit via a hose and may be removably attachable to the diverter unit. In some embodiments, a hand shower may be removably docked to the diverter unit via magnetic attraction. Accordingly, in some embodiments, a filter assembly may comprise a filter cartridge, a magnet, and a filter cap. Shower assemblies containing a removably docked hand shower to a diverter unit may be termed “2-in-1” shower assemblies. Some 2-in-1 shower assemblies are described for example in US2018/0193851, incorporated herein by reference.

A present manifold comprises a bore configured to receive a water filter assembly or water filter cartridge. In some embodiments, a water filter cartridge may be substantially cylinder-shaped, and likewise a manifold bore may be correspondingly substantially cylinder-shaped. In some embodiments, a water filter cartridge may have an end containing both an inlet an outlet. A manifold bore may have an inlet and an outlet positioned towards an inner end thereof. In some embodiments, installation of a filter assembly or filter cartridge in a manifold bore will comprise coupling of a filter cartridge inlet to the manifold inlet and coupling of a filter cartridge outlet to the manifold outlet.

In some embodiments, a manifold inlet port may be positioned in a substantially annular manifold inlet, and a manifold outlet port may be positioned in a substantially annular manifold outlet. A manifold inlet and a manifold outlet may be concentric. A manifold inlet and a manifold outlet may be coplanar. A manifold inlet and a manifold outlet may be annular. A manifold inlet and manifold outlet may be concave. A filter cartridge may have an inlet radial extension and an outlet radial extension configured to mate with and couple to a concave manifold inlet and outlet. Filter cartridge radial extensions may be concentric.

In other embodiments, a manifold inlet and a manifold outlet may comprise radial extensions configured to couple to corresponding radial a concave inlet and outlet of a filter cartridge.

A water filter assembly/cartridge may be removably installed in a manifold. Removable installation or insertion of a filter assembly may be accomplished via threaded engagement/disengagement, via a quarter turn/removal, via a compression spring mechanism, via a simple “plug-type” insertion/removal, and the like.

In some embodiments, a water filter assembly may comprise a filter cartridge and a filter cap. A filter cap may comprise a handle for one to grasp for installation and removal of a filter assembly from the manifold. In some embodiments, a filter cap may comprise one or more features to removably attach it to a filter cartridge, for instance “snap-on” features. In some embodiments, a filter cartridge may comprise a radial extension to couple to a snap-on feature of a filter cap. In certain embodiments, a filter cap may comprise a threaded portion for threadingly engaging and disengaging a threaded manifold bore. In certain embodiments, a filter cap may comprise a “stop” feature to ensure proper installation of a filter cartridge and proper alignment of a visible filter cap handle.

In some embodiments, a filter assembly may comprise an O-ring about an inlet radial extension and an O-ring about an outlet radial extension. The O-rings may form a seal with a manifold inlet and outlet upon installation of the filter assembly. A filter assembly may comprise grooves adapted to receive O-rings.

In certain other embodiments, a filter cartridge, and a corresponding manifold bore, may be non-annular and/or non-cylinder shaped. In some embodiments, a filter cartridge may have a shape of a tapered bottle stopper. In other embodiments, a filter cartridge may have a non-annular shape, for example a rectangle, square, elliptical, or other shape.

In some embodiments, a water filter inlet and outlet may be coplanar. A water filter inlet and outlet may each be annular. A water filter inlet and outlet may be concentric, with one encircling the other.

In some embodiments, a filter cartridge may have a length of from any of about 40 mm, about 41 mm, about 42 mm, about 43 mm, about 44 mm or about 45 mm, to any of about 46 mm, about 47 mm, about 48 mm, about 49 mm, about 50 mm, about 51 mm, about 52 mm, about 53 mm, about 54 mm, about 55 mm, about 56 mm, about 57 mm, about 58 mm, about 59 mm or about 60 mm, or more.

In some embodiments, a filter cartridge may have a diameter of from any of about 40 mm, about 41 mm, about 42 mm, about 43 mm, about 44 mm or about 45 mm, to any of about 46 mm, about 47 mm, about 48 mm, about 49 mm, about 50 mm, about 51 mm, about 52 mm, about 53 mm, about 54 mm, about 55 mm, about 56 mm, about 57 mm, about 58 mm, about 59 mm or about 60 mm, or more. In general, a filter cartridge diameter will not include any radially protruding features.

In some embodiments, a manifold bore may comprise a diameter of from any of about 41 mm, about 42 mm, about 43 mm, about 44 mm or about 45 mm, to any of about 46 mm, about 47 mm, about 48 mm, about 49 mm, about 50 mm, about 51 mm, about 52 mm, about 53 mm, about 54 mm, about 55 mm, about 56 mm, about 57 mm, about 58 mm, about 59 mm or about 60 mm, about 61 mm, or more. For a non-annular or non-cylindrical shape, a diameter may be considered as a longest measure. In some embodiments, a manifold bore diameter may be from about 2 mm, about 3 mm, or about 4 mm, to any of about 5 mm, about 6 mm, or about 7 mm, or more larger than a filter cartridge diameter. This may be in part to accommodate a portion of a filter cap.

In some embodiments, a manifold bore may comprise a depth of from any of about 40 mm, about 41 mm, about 42 mm, about 43 mm, about 44 mm or about 45 mm, to any of about 46 mm, about 47 mm, about 48 mm, about 49 mm, about 50 mm, about 51 mm, about 52 mm, about 53 mm, about 54 mm, about 55 mm, about 56 mm, about 57 mm, about 58 mm, about 59 mm or about 60 mm, or more.

In some embodiments, a water filter cartridge may have about a same diameter and length. In an embodiment wherein a water filter cartridge is substantially cylinder-shaped, this will mean the cylinder shape may be circumscribed on a sphere. Likewise for a corresponding substantially cylinder-shaped manifold bore.

In some embodiments, a water filter may comprise an inner bore comprising a filter media M1 and an outer bore comprising a filter media M2. In some embodiments, source water (unfiltered water) is directed to a filter manifold in a first flow direction F1. The manifold will direct source water to a water filter assembly in a second flow direction F2 and through filter media M1 towards an outer end of the filter cartridge. The manifold will receive filtered water in a third flow direction F3 through media M2. The manifold will then direct filtered water out and to a shower head.

In some embodiments flow path F2 through M1 and flow path F3 through M2 are axially aligned and are in substantially opposite directions.

In other embodiments, this configuration may be reversed, that is, source water may enter an outer bore of a water filter media M2, and exit through a filter inner bore having media M1.

A filter cartridge inner bore may be substantially axially positioned along a central core. A filter cartridge outer bore may be concentric with an inner bore and encircle the inner bore.

In some embodiments a filter cartridge comprises a continuous wall defined by a first continuous end and a second end, wherein the second end comprises a water filter inlet and outlet. In some embodiments a filter cartridge is substantially cylinder-shaped, wherein a water inlet and outlet are positioned at a second end of the cylinder shape, and the remainder of the shape is continuous.

In some embodiments, a first end of a water filter cartridge may comprise an open space in fluid communication with an inner bore and an outer bore of the cartridge. Fluid may flow through the inner bore comprising media M1 and into the open space near the cartridge first end, and from the first end open space through the outer bore comprising media M2 and out of the filter. As discussed, the configuration may be reversed.

In some embodiments, filter media include one or more of hollow carbon, carbon block, activated carbon, redox media, or polyphosphate beads. Redox media includes KDF (kinetic degradation fluxion) media.

Media M1 and M2 may be the same or different. For example, M1 may comprise hollow carbon and M2 may comprise KDF. In other embodiments M1 may comprise KDF and M2 may comprise hollow carbon. In still other embodiments, both M1 and M2 may comprise KDF. Each of M1 and M2 may be a uniform single media or a mixture of media. A media mixture may comprise discrete sequences of different media, homogeneous mixtures, or graded mixtures.

In some embodiments, a filter assembly may comprise one or more features to indicate a remaining useful life of the filter media. In some embodiments, an indicator may be an LED (light emitting diode) light that activates when the filter cartridge requires changing. In other embodiments, a visible indicator strip may change color, for example colorless to red, upon reaching a filter end-of-life. In some embodiments, an LCD (liquid crystal display) may provide a color array of light to dark to indicate a filter requires changing. In still other embodiments, a time-based chemical indicator may change from clear or light-colored to a visible color or dark to indicate the filter needs to be changed. Each of these embodiments may be provided for example within a window on a filter cap.

Also subject of the disclosure is a filter assembly comprising media M1 and M2 as described herein. Also subject of the disclosure is a filter manifold as described herein.

Following are certain embodiments of the disclosure

In a first embodiment, disclosed is a shower assembly comprising a shower head; and a manifold configured to removably receive a water filter assembly; wherein the manifold comprises a bore having an outward-facing open end to receive the water filter assembly and a fluid inlet and a fluid outlet, the manifold inlet is downstream of and in fluid communication with a water source, and the manifold outlet is upstream of and in fluid communication with the shower head.

In a second embodiment, disclosed is a shower assembly according to the first embodiment, wherein the manifold inlet and outlet are positioned towards an inner end of the bore.

In a third embodiment, disclosed is a shower assembly according to the first or second embodiments, wherein the manifold inlet is configured to receive source water from the water source in a first flow direction and to provide the source water to the water filter assembly in a second flow direction, and the manifold outlet is configured to receive filtered water from the water filter assembly in a third flow direction and to provide the filtered water to the shower head, wherein the second and third flow directions are substantially opposite each other.

In a fourth embodiment, disclosed is a shower assembly according to any of the preceding embodiments, comprising a water filter assembly removably disposed in the manifold bore, wherein the water filter assembly is coupled to the manifold such that the manifold inlet is coupled to a water filter assembly inlet and the manifold outlet is coupled to a water filter assembly outlet.

In a fifth embodiment, disclosed is a shower assembly according to embodiment 4, wherein the coupling is achieved via O-rings positioned in grooves about the filter assembly inlet and the filter assembly outlet. In a sixth embodiment, disclosed is a shower assembly according to embodiments 4 or 5, wherein the water filter assembly inlet and water filter assembly outlet are coplanar.

In a seventh embodiment, disclosed is a shower assembly according to any of embodiments 4 to 6, wherein the water filter assembly inlet and water filter assembly outlet are concentric. In an eighth embodiment, disclosed is a shower assembly according to any of the preceding embodiments, wherein the manifold bore is substantially cylinder-shaped.

In a ninth embodiment, disclosed is a shower assembly according to any of embodiments 1 to 7, wherein the manifold bore is non-annular.

In a tenth embodiment, disclosed is a shower assembly according to any of the preceding embodiments, wherein the manifold bore comprises a diameter of from about 50 mm to about 60 mm. In an eleventh embodiment, disclosed is a shower assembly according to any of the preceding embodiments, wherein the manifold bore comprises a depth of from about 45 mm to about 55 mm.

In a twelfth embodiment, disclosed is a shower assembly according to any of the preceding embodiments, wherein a manifold outlet port and a manifold inlet port are positioned in the manifold outlet and a manifold inlet, respectively. In a thirteenth embodiment, disclosed is a shower assembly according to any of the preceding embodiments, wherein the manifold outlet and the manifold inlet are concentric, and are configured to couple with a filter assembly outlet and filter assembly inlet, respectively.

In a fourteenth embodiment, disclosed is a shower assembly according to any of the preceding embodiments, wherein the manifold outlet and manifold inlet are coaxial. In a fifteenth embodiment, disclosed is a shower assembly according to any of the preceding embodiments, wherein the second and third flow directions are substantially axially aligned.

In a sixteenth embodiment, disclosed is a shower assembly according to any of the preceding embodiments, wherein the first, second, and third flow directions are substantially axially aligned. In a seventeenth embodiment, disclosed is a shower assembly according to any of embodiments 1 to 15, wherein the first and second flow directions are substantially perpendicular.

In an eighteenth embodiment, disclosed is a shower assembly according to any of the preceding embodiments, wherein the second and third flow directions are substantially horizontal. In a nineteenth embodiment, disclosed is a shower assembly according to any of the preceding embodiments, wherein the manifold comprises a feature to engage and to disengage the water filter assembly. In a twentieth embodiment, disclosed is a shower assembly according to any of the preceding embodiments, wherein the manifold comprises a threaded portion configured to threadingly engage and disengage the water filter assembly.

In a twenty-first embodiment, disclosed is a shower assembly according to any of the preceding embodiments, wherein the shower assembly comprises a shower bar, and wherein the shower bar is in fluid communication with the water source and with the manifold.

In a twenty-second embodiment, disclosed is a shower assembly according to any of the preceding embodiments, wherein the shower assembly comprises a shower bar, and wherein the manifold is positioned along the shower bar. In a twenty-third embodiment, disclosed is a shower assembly according to any of the preceding embodiments, wherein the manifold is positioned in the shower head.

In a twenty-fourth embodiment, disclosed is a shower assembly according to any of the preceding embodiments, wherein the manifold is positioned in one or more of a front portion of the shower head, a bottom portion of the shower head, a top portion of the shower head, or a rear portion of the shower head.

In a twenty-fifth embodiment, disclosed is a shower assembly according to any of the preceding embodiments, wherein the manifold is positioned in a front, face portion of the shower head, creating an area of the face portion having no spray nozzles, and wherein the shower head comprises one or more supplemental spray nozzles configured to compensate for the face portion having no spray nozzles.

In a twenty-sixth embodiment, disclosed is a shower assembly according to any of the preceding embodiments, comprising a hand shower and an add-on water filter unit, wherein the add-on unit comprises the manifold and a cradle to hold the hand shower.

In a twenty-seventh embodiment, disclosed is a shower assembly according to any of the preceding embodiments, comprising a diverter in fluid communication and downstream of the manifold, the diverter configured to selectively direct filtered water to a shower head and/or a hand shower.

In a twenty-eighth embodiment, disclosed is a shower assembly according to any of the preceding embodiments, comprising a diverter configured to selectively direct filtered water to a shower head and/or a hand shower, wherein the diverter is directly coupled to the manifold.

In a twenty-ninth embodiment, disclosed is a shower assembly according to any of the preceding embodiments, comprising a diverter unit configured to selectively direct filtered water to a shower head and/or a hand shower, wherein the diverter unit comprises the manifold, the shower head is configured to be removably fluidly coupled to the diverter unit, and wherein the hand shower is configured to be removably attachable to the diverter unit.

In a thirtieth embodiment, disclosed is a shower assembly according to any of the preceding embodiments, comprising an in-wall valve assembly, and wherein the manifold is positioned in the in-wall valve assembly.

In a thirty-first embodiment, disclosed is a shower assembly according to any of the preceding embodiments, comprising an add-on water filter unit in fluid communication with and downstream of the water source, in fluid communication with and upstream of the shower head, and wherein the manifold is positioned in the add-on unit.

In a thirty-second embodiment, disclosed is a shower assembly according to any of the preceding embodiments, wherein the water filter assembly comprises a filter cartridge and a filter cap. In a thirty-third embodiment, disclosed is a shower assembly according to any of the preceding embodiments, wherein the water filter assembly comprises a filter cartridge, a filter cap, and a magnetic material.

In a thirty-fourth embodiment, disclosed is an add-on water filter unit, configured to removably receive a water filter assembly and to be installed in-line in a shower assembly, downstream of and in fluid communication with a water source and upstream of and in fluid communication with a shower head. In a thirty-fifth embodiment, disclosed is add-on water filter unit according to embodiment 34, wherein the unit comprises a hand shower cradle and/or is coupled to a fixed shower head.

In a thirty-sixth embodiment, disclosed is an add-on water filter unit according to embodiments 34 or 35, comprising a manifold having a bore having an outward-facing open end to receive the water filter assembly and a fluid inlet and a fluid outlet, wherein the manifold inlet is configured to be downstream of and in fluid communication with the water source and the manifold outlet is configured to be upstream of and in fluid communication with the shower head.

In a thirty-seventh embodiment, disclosed is an add-on water filter unit according to embodiment 36, wherein the manifold inlet and manifold outlet are positioned towards an inner end of the manifold bore.

In a thirty-eighth embodiment, disclosed is a water filter cartridge comprising a continuous wall defined by a first end and an opposing second end, wherein the first end is continuous and the second end comprises a water filter inlet and a water filter outlet. In a thirty-ninth embodiment, disclosed is a water filter cartridge according to embodiment 38, wherein the filter inlet and filter outlet are coplanar. In a fortieth embodiment, disclosed is a water filter cartridge according to embodiments 38 or 39, wherein the filter inlet and filter outlet are concentric. In a forty-first embodiment, disclosed is a water filter cartridge according to any of embodiments 38 to 40, wherein the filter outlet encircles the filter inlet.

In a forty-second embodiment, disclosed is a water filter cartridge according to any of embodiments 38 to 40, wherein the filter inlet encircles the filter outlet.

In a forty-third embodiment, disclosed is a water filter cartridge according to any of embodiments 38 to 42, comprising a filter media selected from one or more of hollow carbon, carbon block, activated carbon, KDF, or polyphosphate beads.

In a forty-fourth embodiment, disclosed is a water filter cartridge according to any of embodiments 38 to 43, comprising an inner bore and an outer bore, configured to receive filter media.

In a forty-fifth embodiment, disclosed is a water filter cartridge according to embodiment 44, comprising a flow path such that water flows through the filter inlet and inner bore in a second flow direction, and from near the filter cartridge first end through the outer bore in a third flow direction, wherein the second and third flow directions are substantially opposite each other.

In a forty-sixth embodiment, disclosed is a water filter cartridge according to embodiment 44, comprising a flow path such that water flows through the filter inlet and outer bore in a second flow direction, and from near the filter cartridge first end through the inner bore in a third flow direction, wherein the second and third flow directions are substantially opposite each other.

In a forty-seventh embodiment, disclosed is a water filter cartridge according to embodiments 45 or 46, wherein the inner bore contains a first filter media and the outer bore contains a second filter media, and wherein the first and second filter media are the same or different.

In a forty-eighth embodiment, disclosed is a water filter assembly comprising the water filter cartridge according to any of embodiments 38 to 47 and a cap. In a forty-ninth embodiment, disclosed is a water filter assembly according to embodiment 48, wherein the cap comprises a feature configured to removably engage the water filter cartridge.

In a fiftieth embodiment, disclosed is a water filter assembly according to embodiments 48 or 49, wherein the cap comprises a feature configured to removably engage a manifold configured to receive the water filter assembly. In a fifty-first embodiment, disclosed is a water filter assembly according to embodiment 50, wherein the cap is threaded and configured to removably threadingly engage the manifold. In a fifty-second embodiment, disclosed is a water filter assembly according to any of embodiments 50 or 51, wherein the cap comprises a feature to align a cap handle with the manifold.

The term “coupled” means that an element is “attached to” or “associated with” another element. Coupled may mean directly coupled or coupled through one or more other elements. An element may be coupled to an element through two or more other elements in a sequential manner or a non-sequential manner. The term “via” in reference to “via an element” may mean “through” or “by” an element. Coupled or “associated with” may also mean elements not directly or indirectly attached, but that they “go together” in that one may function together with the other.

The terms “fluidly coupled” or “fluidly connected” may be synonymous with “flow communication” means for example configured for liquid or gas flow there through. The terms “upstream” and “downstream” indicate a direction of gas or fluid flow, that is, gas or fluid will flow from upstream to downstream.

The term “towards” in reference to a of point of attachment or a location, may mean at exactly that location or point or, alternatively, may mean closer to that point or location than to another distinct point or location, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more of the definition; for example the term “substantially perpendicular” may mean the 90° perpendicular angle may mean “about 90°”. The term “generally” may be equivalent to “substantially”.

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

1. A shower assembly comprising
a shower head; and
a manifold configured to removably receive a water filter assembly;
wherein
the manifold comprises a bore having an outward-facing open end to receive the water filter assembly, wherein the manifold is downstream of and in fluid communication with a water source, and is upstream of and in fluid communication with the shower head.

2. The shower assembly according to claim 1, comprising a water filter assembly removably disposed in the manifold bore, wherein the water filter assembly is coupled to the manifold.

3. The shower assembly according to claim 1, wherein the shower assembly comprises a shower bar, and wherein the shower bar is in fluid communication with the water source and with the manifold.

4. The shower assembly according to claim 3, wherein the manifold is positioned along the shower bar.

5. The shower assembly according to claim 1, wherein the manifold is positioned in the shower head.

6. The shower assembly according to claim 5, wherein the manifold is positioned in one or more of a front portion of the shower head, a bottom portion of the shower head, a top portion of the shower head, or a rear portion of the shower head.

7. The shower assembly according to claim 5, wherein the manifold is positioned in a front, face portion of the shower head, creating an area of the face portion having no spray nozzles, and wherein the shower head comprises one or more supplemental spray nozzles configured to compensate for the face portion having no spray nozzles.

8. The shower assembly according to claim 1, comprising a hand shower and an add-on water filter unit, wherein the add-on unit comprises the manifold and a cradle to hold the hand shower.

9. The shower assembly according to claim 1, comprising a diverter in fluid communication and downstream of the manifold, the diverter configured to selectively direct filtered water to a shower head and/or a hand shower.

10. The shower assembly according to claim 1, comprising a diverter configured to selectively direct filtered water to a shower head and/or a hand shower, wherein the diverter is directly coupled to the manifold.

11. The shower assembly according to claim 1, comprising a diverter unit configured to selectively direct filtered water to a shower head and/or a hand shower, wherein the diverter unit comprises the manifold, and wherein the hand shower is configured to be removably attachable to the diverter unit.

12. The shower assembly according to claim 11, wherein the shower head is fluidly coupled to the diverter unit.

13. The shower assembly according to claim 11, wherein the shower head is configured to be removably fluidly coupled to the diverter unit.

14. The shower assembly according to claim 1, comprising an in-wall valve assembly, and wherein the manifold is positioned in or associated with the in-wall valve assembly.

15. The shower assembly according to claim 1, comprising an add-on water filter unit in fluid communication with and downstream of the water source, in fluid communication with and upstream of the shower head, and wherein the manifold is positioned in the add-on unit.

16. The shower assembly according to claim 1, wherein the water filter assembly comprises a filter cartridge.

17. The shower assembly according to claim 1, wherein the water filter assembly comprises a filter cartridge and a magnetic material.

18. An add-on water filter unit, configured to removably receive a water filter assembly and to be installed in-line in a shower assembly, downstream of and in fluid communication with a water source and upstream of and in fluid communication with a shower head.

19. The add-on water filter unit according to claim 18, wherein the unit comprises a hand shower cradle and/or is coupled to a fixed shower head.

20. The add-on water filter unit according to claim 18, comprising a manifold having a bore having an outward-facing open end to receive the water filter assembly, wherein the manifold is configured to be downstream of and in fluid communication with the water source and upstream of and in fluid communication with the shower head.
